(19) United States
(12) Patent Application Publication
(10) Pub. No.: US 2022/0190434 A1
(43) Pub. Date: Jun. 16, 2022

(54) COMPOSITE BATTERY COVER

(71) Applicant: GM GLOBAL TECHNOLOGY OPERATIONS LLC, Detroit, MI (US)

(72) Inventors: Venkateshwar R. AITHARAJU, Troy, MI (US); Xiaosong HUANG, Novi, MI (US); Bhavesh SHAH, Troy, MI (US); Gustavo CIBRIAN SALAZAR, Belle River (CA)

(73) Assignee: GM GLOBAL TECHNOLOGY OPERATIONS LLC, Detroit, MI (US)

(21) Appl. No.: 17/119,585

(22) Filed: Dec. 11, 2020

(51) Int. Cl. H01M 50/367; H01M 50/16; H01M 50/164; H01M 50/157

(52) U.S. Cl. CPC H01M 50/367; H01M 50/16; H01M 2220/20; H01M 50/157; H01M 50/164

(57) ABSTRACT

The present disclosure relates to composite battery covers including one or more integral vent members configured to release pressure. An example composite battery cover includes a continuous sheet having a first stiffness and one or more vent members defined in the continuous sheet. Each of the one or more vent members may include a first area having a second stiffness and/or a second area having a third stiffness. The second stiffness may be different from the first stiffness. The third stiffness may be different from the second stiffness and/or the first stiffness. The stiffness and strength of the continuous sheet and/or one or more vent members may be controlled by variable thicknesses and/or fiber loadings.

### INTRODUCTION

This section provides background information related to the present disclosure which is not necessarily prior art.

Current designs for battery covers often include one or more openings and one or more vent covers configured to cover the one or more openings that is coupled to a housing to one or more bolts. Such materials and methods for forming the same are often costly and time consuming. It would be desirable to develop battery cover materials and designs, and methods of forming the same, that provide improve efficiency, and also reduces costs.

### SUMMARY

This section provides a general summary of the disclosure, and is not a comprehensive disclosure of its full scope or all of its features.

The present disclosure relates to a composite battery cover including one or more integral vent members configured to release pressure.

In various aspects, the present disclosure provides a composite battery cover that includes a continuous sheet having a first stiffness and one or more vent members defined in the continuous sheet. Each of the one or more vent members may include a first area having a second stiffness. The second stiffness may be different from the first stiffness.

In one aspect, the second stiffness may be greater than or equal to about 5% to less than or equal to about 25% of the first stiffness.

In one aspect, the continuous sheet may have a first average thickness and the first area may have a second average thickness. The first and second average thicknesses may be different.

In one aspect, the continuous sheet may have a first fiber loading and the first area may have a second fiber loading. The first and second fiber loadings may be different.

In one aspect, the first area may be a polymeric domain including a low-melting temperature polymer.

In one aspect, each of the one or more vent members may further includes a second area having a third stiffness. The third stiffness may be different from the first stiffness and the second stiffness.

In one aspect, the third stiffness may be greater than or equal to about 75% to less than or equal to about 600% of the first stiffness.

In one aspect, the continuous sheet may have a first average thickness, the first area may have a second average thickness, and the second area may have a third average thickness. The first, second, and third average thicknesses may be different.

In one aspect, the first average thickness may be greater than or equal to about 2.0 mm to less than or equal to about 5.0 mm; the second average thickness may be greater than or equal to about 0.2 mm to less than or equal to about 4.0 mm; and the third average thickness may be greater than or equal to about 2.0 mm to less than or equal to about 6.0 mm.

In one aspect, the continuous sheet may have a first fiber loading, the first area may have a second fiber loading, and the second area may have a third fiber loading. The first, second, and third fiber loadings may be different.

In one aspect, the first fiber loading may be greater than or equal to about 30 vol. % to less than or equal to about 60 vol. %; the second fiber loading may be greater than or equal to about 0 vol. % to less than or equal to about 60 vol. %; and the third fiber loading may be greater than or equal to about 30 vol. % to less than or equal to about 60 vol. %.

In one aspect, the first area may form a substantially planar surface and the second area may form a bridge that extends between the substantially planar surface and a main surface of the continuous sheet.

In one aspect, the substantially planar surface may define a convex member having a maximum height greater than or equal to about 2 mm to less than or equal to about 10 mm.

In one aspect, the substantially planar surface may define a concave member having a maximum depth greater than or equal to about 2 mm to less than or equal to about 10 mm.

In one aspect, the composite battery cover may further include one or more seal materials. The one or more seal materials may be integrated with the continuous sheet.

In one aspect, the composite battery cover may further include an expandable graphite. The expandable graphite may be integrated with the continuous sheet.

In one aspect, the composite battery cover further comprises one or more exhaust channels configured to direct exhaust. Each exhaust channel may be in communication with at least one of the one or more vent members.

In various aspects, the present disclosure provides a method for preparing a composite battery cover. The composite battery cover may include a continuous sheet having one or more polymeric domains defined therein. The method may include obtaining a composite sheet material having one or more openings; filling the one or more openings with a polymeric composite or covering the one or more opening with the polymeric composite so as to form a precursor sheet having one or more polymeric domains; and applying heat and pressure to the precursor sheet so as to form the continuous sheet comprising the one or more polymeric domains. The composite sheet material may have a first fiber loading. The polymeric composite may have a second fiber loading. The first and second fiber loadings may be different.

In one aspect, the method further includes shaping the composite sheet material having the one or more opening.

In one aspect, the method further includes shaping the one or more continuous so as to form the composite battery cover.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1A is a top-down view of an example composite battery cover having one or more vents in accordance with various aspects of the current technology;

FIG. 1B is a top-down view of another example composite battery cover having a depression vent in accordance with various aspects of the current technology;

FIG. 2A is a cross-sectional view along line 2A of an embossment vent illustrated in FIG. 1A;

FIG. 2B is a cross-sectional view along line 2B of a depression vent illustrated in FIG. 1B;

FIG. 3 is a sideview of a compression molding system for forming a composite battery cover having one or more embossment vents, for example, as illustrated in FIG. 1A;

FIG. 4 is top-down view of yet another example composite battery cover having an integrated metallic mesh;

FIG. 5 is a top-down view of yet another example composite battery cover having one or more vents in accordance with various aspects of the current technology;

FIG. 6A is a flowchart illustration of a method for forming a composite battery cover having one or more polymeric vents, for example, as illustrated in FIG. 5;

FIG. 6B is a cross-sectional view of a composite sheet material having one or more openings;

FIG. 6C is a cross-sectional view of the composite sheet material of FIG. 6B where the one or more openings are filled with a polymeric filler material;

FIG. 6D is a cross-sectional view of the composite sheet material of FIG. 6B wherein the one or more openings are covered by a polymeric patch;

FIG. 6E is a sideview of a compression molding system for forming a composite battery cover having one or more polymeric vents, for example, as illustrated in FIG. 5;

FIG. 6F is a sideview of a compression molding system for molding a composite sheet material having one or more openings, for example, as illustrated in FIG. 6B;

FIG. 7A is a top-down view of an example composite battery cover having one or more vents in communication with one or more exhaust channels in accordance with various aspects of the current technology; and

FIG. 7B is a top-down view of another example composite battery cover having one or more vents in communication with one or more exhaust channels in accordance with various aspects of the current technology.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology is directed to composite battery covers having one or more integral vent members or valves that are configured to release pressure from within covered enclosures. As detailed below, in certain variations, the one or more integral vent members may include variable stiffnesses. For example, the one or more integral vent members may include variable thicknesses and/or fiber loadings. The one or more integral vent members may include embossments or depressions having such variable thicknesses and/or fiber loadings. In other variations, the one or more integral vent members may include one or more over-molded regions that include polymeric materials, for example polymeric composites having low yield and low melting temperatures that can be introduced prior to, and in certain aspects, after, molding of the battery cover.

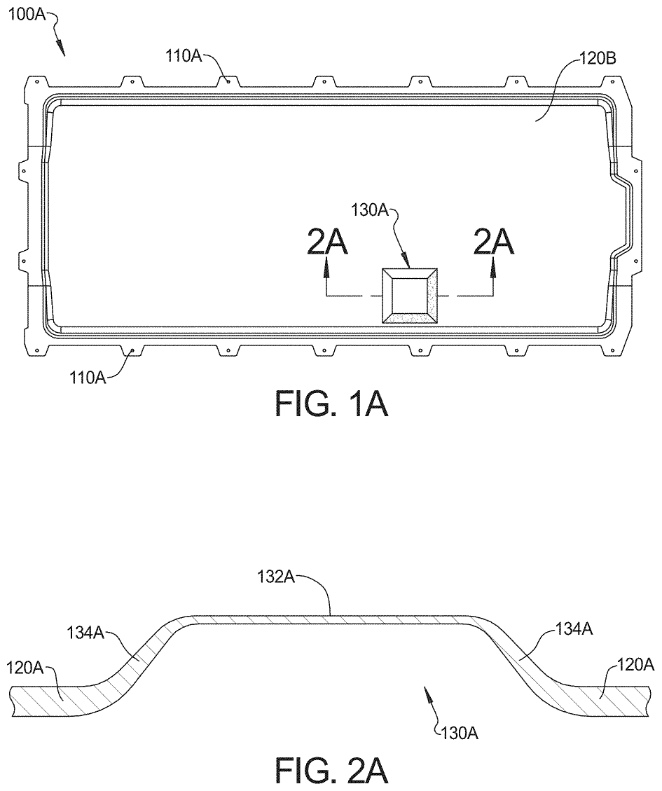

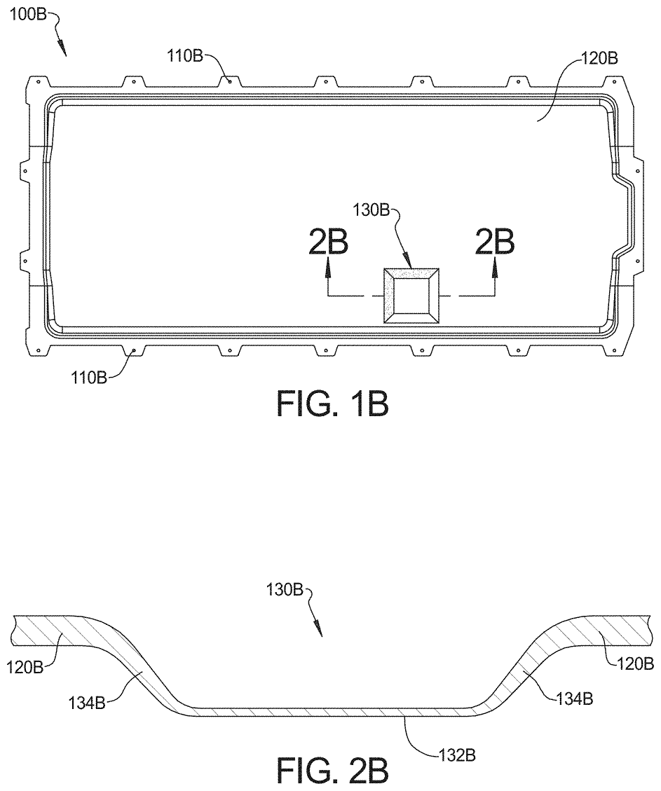

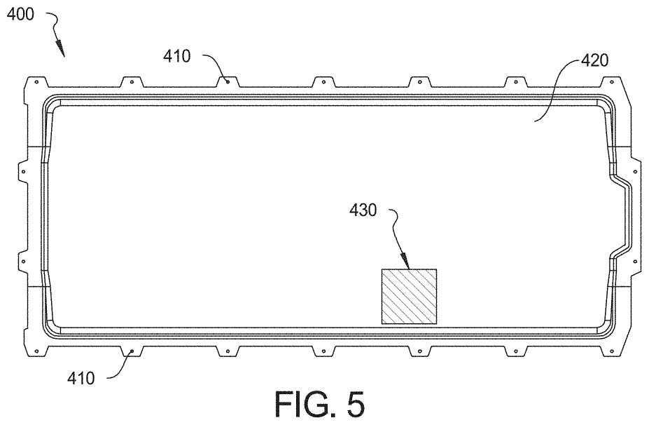

Such composite battery covers having one or more integral vent members may be used as covers for electric vehicle battery enclosures. For example, FIGS. 1A-1B and FIG. 5 illustrate composite battery covers 100A, 100B, 400 for an electric vehicle battery enclosure where the one or more integral vent members are configured to release pressure from the battery enclosure, such as in the instance of thermal runaway propagation (“TRP”). Although the illustrated examples are directed to composite battery covers for electric vehicle battery enclosures, the skilled artisan will recognize that the current technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example.

FIGS. 1A and 1B are top-down views of a similar composite battery covers 100A, 100B having one or more integral vent members 130A, 130B. For example, in each instance, the respective composite battery cover 100A, 100B includes a plurality of coupling members 110A, 100B for securing the composite battery cover 100A, 100B to an enclosure, such as an electric vehicle battery enclosure, and a first or main enclosing surface 120A, 120B that includes the one or more integral vent members 130A, 130B. For example, as illustrated, each main enclosing surface 120A, 120B may include a single vent member 130A, 130B. The main enclosing surface 120A, 120B may have a general shape that corresponds with the structure to be enclosed (e.g., electric vehicle battery enclosure).

The one or more integral vent members 130A, 130B may include variable stiffnesses. For example, in each instance, the main enclosing surface 120A, 120B may have a first stiffness. The each vent member 130A, 130B may include one or more first areas or regions 132A, 132B and/or one or more second areas or regions 134A, 134B.

Each of the one or more first areas 132A, 132B may have a second stiffness. The second stiffness may be different from the first stiffness. For example, the second stiffness may be less than the first stiffness. In some example embodiments, the second stiffness may be greater than or equal to about 5% to less than or equal to about 35%, and in certain aspects, optionally greater than or equal to about 10% to less than or equal to about 25%, of the first stiffness.

Each of the one or more second areas 134A, 134B may have a third stiffness. The third stiffness may be different from the first stiffness and/or the second stiffness. In certain instances, the third stiffness may be less than the first stiffness. In other instances, the third stiffness may be greater than or equal to the first stiffness. In each instance, the third stiffness may be greater than the second stiffness. For example, the third stiffness may be greater than or equal to about 75% to less than or equal to about 600%, optionally greater than or equal to about 75% to less than or equal to about 200%, and in certain aspects, optionally greater than or equal to about 85% to less than or equal to about 150%, of the first stiffness.

The stiffness and strength of the first and second regions 132A, 132B, 134A, 134B of the one or more integral vents 130A, 130B may be controlled by variable thicknesses and/or fiber loadings.

For example, in certain variations, the main enclosing surface 120A, 120B may have a first sheet thickness. The one or more first areas 132A, 132B may have a second sheet thickness; and the one or more second areas 134A, 134B may have a third sheet thickness. The first sheet thickness may be greater than or equal to about 2.0 mm to less than or equal to about 5.0 mm, optionally greater than or equal to about 2.0 mm to less than or equal to about 4.0 mm, and in certain variation, optionally greater than or equal to about 2.5 mm to less than or equal to about 4.0 mm; the second sheet thickness may be greater than or equal to about 0.2 to less than or equal to about 4.0 mm, and in certain variations, optionally about 1 mm; and the third sheet thickness may be greater than or equal to about 2.0 mm to less than or equal to about 6.0 mm, and in certain variations, optionally greater than or equal to about 2.5 mm to less than or equal to about 6.0 mm.

Similarly, in certain variations, the main enclosing surface 120A, 120B may have a first fiber loading. The one or more first areas 132A, 132B may have a second fiber loading; and the one or more second areas 134A, 134B may have a third fiber loading. The first fiber loading may be greater than or equal to about 30 vol. % to less than or equal to about 60 vol. %, and in certain aspects, optionally greater than or equal to about 30 vol. % to less than or equal to about 50 vol. %. The second fiber loading may be greater than or equal to about 0 vol. % to less than or equal to about 60 vol. %, and in certain aspects, optionally greater than or equal to about 0 vol. % to less than or equal to about 35 vol. %. The third fiber loading may be greater than or equal to about 30 vol. % to less than or equal to about 60 vol. %, and in certain aspects, optionally greater than or equal to about 30 vol. % to less than or equal to about 50 vol. %.

In certain variations, the one or more integral vent members 130A, 130B include embossments or depressions. For example, FIG. 1A is a top-down view of a composite battery cover 100A having an embossment vent 130A; and FIG. 1B is a top-down view of a similar composite battery cover 100B having a depression vent 130B.

FIG. 2A is a cross-sectional view of the vent member 130A, as shown in FIG. 1A, along line 2A. As illustrated in FIG. 2A, the vent member 130A is an embossment having a surface 132A raised or bulging from the main enclosing surface 120A. For example, in certain instances, the vent member 130A may have a general convex shape that defines the raised surface 132A. Using the main enclosing surface 120A as a reference, the raised surface 132A may have a height greater than or equal to about 2 mm to less than or equal to about 10 mm. The raised surface 132A may be a substantially planar surface.

The raised surface 132A may have, for example, a general rectangular shape as illustrated in FIG. 1A. In other instances, the raised surface 132A may be other shapes or configurations as would be recognized by the skilled artisan. For example, though not illustrated, in certain variations, the raised surface 132A may have a circular or triangular shape or configuration. In each instance, the raised surface 132A may have a radius greater than or equal to about 1.0 mm to less than or equal to about 3.0 mm, and in certain variations, optionally greater than or equal to about 2.0 mm to less than or equal to about 3.0 mm. The vent member 130A may have an overall width greater than or equal to about 1 inches to less than or equal to about 4 inches.

The sheet thickness of the composite material defining the composite battery cover 100A may be variable in the region of the vent member 130A. For example, as illustrated in FIG. 2A, the main enclosing surface 120A may have a first sheet thickness, and the raised surface 132A may have a second sheet thickness. As illustrated, a sloped portion 134A extends between the main enclosing surface 120A and the raised surface 132A. The sloped portion 134A may have a third sheet thickness. The first, second, and third sheet thicknesses may be different. For example, in certain variations, the first sheet thickness may be greater than or equal to about 2.0 mm to less than or equal to about 5.0 mm, optionally greater than or equal to about 2.0 mm to less than or equal to about 4.0 mm, and in certain variation, optionally greater than or equal to about 2.5 mm to less than or equal to about 4.0 mm; the second sheet thickness may be greater than or equal to about 0.2 to less than or equal to about 4.0 mm, and in certain variations, optionally about 1 mm; and the third sheet thickness may be greater than or equal to about 2.0 mm to less than or equal to about 6.0 mm, and in certain variations, optionally greater than or equal to about 2.5 mm to less than or equal to about 6.0 mm.

The fiber loading of the composite material defining the battery cover 100A may be variable in the region of the vent member 130A. For example, the main enclosing surface 120A may have a first fiber loading, and the raised surface 132A may have a second fiber loading. The sloped portion 134A that extends between the main enclosing surface 120A and the raised surface 132A may have a third fiber loading. The first, second, and third fiber loadings may be different. For example, in certain variations, the first fiber loading may be greater than or equal to about 30 vol. % to less than or equal to about 60 vol. %, and in certain aspects, optionally greater than or equal to about 30 vol. % to less than or equal to about 50 vol. %. The second fiber loading may be greater than or equal to about 0 vol. % to less than or equal to about 60 vol. %, and in certain aspects, optionally greater than or equal to about 0 vol. % to less than or equal to about 35 vol. %. The third fiber loading may be greater than or equal to about 30 vol. % to less than or equal to about 60 vol. %, and in certain aspects, optionally greater than or equal to about 30 vol. % to less than or equal to about 50 vol. %.

The variable thickness and/or fiber loadings of the venting member 130A create localized areas of weakness that will succumb to stress and fail so as to relieve or vent pressure prior to the thicker regions of the main enclosing surface 120A. For example, the venting members 130A may fail at a pressure greater than or equal to about 15 KPa.

FIG. 2B is a cross-sectional view of the vent member 130B as shown in FIG. 1A along line 2B. As illustrated, the vent member 130B is a depression including a surface 132B depressed or sunken within the main enclosing surface 120B. In certain instances, the vent member 130B may have a general concave shape that defines the depressed surface 132B. For example, using the main enclosing surface 120B as a reference, the depressed surface 132B may have a depth greater than or equal to about 2 mm to less than or equal to about 10 mm. The depressed surface 132B may be a substantially planar surface.

The depressed surface 132B may have, for example, a general rectangular shape as illustrated in FIG. 1B. In other instances, the depressed surface 132B may be other shapes or configurations as would be recognized by the skilled artisan. For example, though not illustrated, in certain variations, the depressed surface 132B may have a circular or triangular shape or configuration. In each instance, the depressed surface 132B may have a radius greater than or equal to about 1.0 mm to less than or equal to about 3.0 mm, and in certain variations, optionally greater than or equal to about 2.0 mm to less than or equal to about 3.0 mm. The vent member 120B may have an overall width greater than or equal to about 1 inches to less than or equal to about 4 inches.

The sheet thickness of the composite material defining the composite battery cover 100B may be variable in the region of the vent member 130B. For example, as illustrated in FIG. 2B, the main enclosing surface 120B may have a first sheet thickness and the depressed surface 132B may have a second sheet thickness. As illustrated, a sloped portion 134B extends between the main enclosing surface 120B and the depressed surface 132B. The sloped portion 134B may have a third sheet thickness. The first, second, and third sheet thicknesses may be different. For example, in certain variations, the first sheet thickness may be greater than or equal to about 2.0 mm to less than or equal to about 5.0 mm, optionally greater than or equal to about 2.0 mm to less than or equal to about 4.0 mm, and in certain variations, optionally greater than or equal to about 2.5 mm to less than or equal to about 4.0 mm; the second sheet thickness may be about 1 mm; and the third sheet thickness may be greater than or equal to about 2.0 mm to less than or equal to about 6.0 mm, and in certain variations, optionally greater than or equal to about 2.5 mm to less than or equal to about 6.0 mm.

The fiber loading of the composite material defining the battery cover 100B may be variable in the region of the vent member 130B. For example, the main enclosing surface 120B may have a first fiber loading, and the raised surface 132B may have a second fiber loading. The sloped portion 134B that extends between the main enclosing surface 120B and the raised surface 132B may have a third fiber loading. The first, second, and third fiber loadings may be different. For example, in certain variations, the first fiber loading may be greater than or equal to about 30 vol. % to less than or equal to about 60 vol. %, and in certain aspects, optionally greater than or equal to about 30 vol. % to less than or equal to about 50 vol. %. The second fiber loading may be greater than or equal to about 0 vol. % to less than or equal to about 60 vol. %, and in certain aspects, optionally greater than or equal to about 0 vol. % to less than or equal to about 35 vol. %. The third fiber loading may be greater than or equal to about 30 vol. % to less than or equal to about 60 vol. %, and in certain aspects, optionally greater than or equal to about 30 vol. % to less than or equal to about 50 vol. %.

The variable thickness and/or fiber loading of the venting member 130B create localized areas of weakness that will succumb to stress and fail so as to relieve or vent pressure prior to the thicker regions of the main enclosing surface 120B. For example, the venting members 130B may fail at a pressure greater than or equal to about 15 KPa

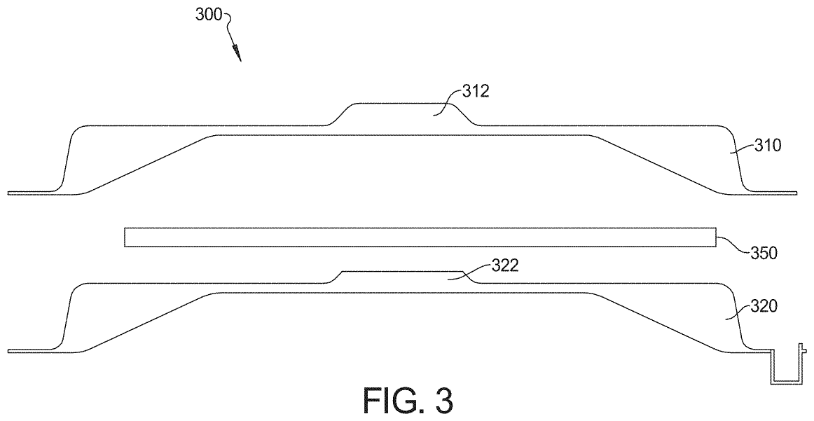

In various aspects, the present disclosure provides methods for preparing composite battery covers having embossment and/or depression vents, such as illustrated in FIGS. 1A and 1B. Compression molding processes may be used. For example, in certain variations, the method may include disposing a composite sheet material 350 between upper and lower dies having predetermined corresponding shapes. For example, as illustrated in FIG. 3, the die assembly 300 may include an upper die 310 having a recess or depress portion 312 and a lower die 320 having a corresponding raise or bulged portion 322 that is configured to be received by the recess portion 312 of the upper die 310 when the upper and lower dies 310, 320 are moved together and pressure applied. In this manner, a composite battery cover having an embossment (such as illustrated in FIG. 1A) may be formed. Though not illustrated, the skilled artisan will understand that a similar process may be used to form a composite battery cover having a depression (such as illustrated in FIG. 1B). For example, a die assembly may have an upper die that includes a raised or bulged portion that is configured to be received by a recess portion of a lower die when the upper and lower dies are moved together and pressure applied.

In certain instances, such as in the instance of non-flowable composite materials (e.g., continuous fiber reinforcement), the methods for preparing composite battery covers may include introducing fiber breakage so as to make the composite material flowable. For example, the methods may include splitting fibers such that average lengths in the selected location are greater than or equal to about 10 mm to less than or equal to about 25 mm, and in certain aspects, optionally greater than or equal to about 10 mm to less than about 20 mm. Such fiber lengths will allow the composite material to flow to form variable thickness areas in the selected locations.

In each instance, the composite sheet material 350 may include a composite material that comprises one or more resins including, for example, one or more of phenolic resins (such as, novolacs, resoles, and the like), thermoset epoxy, phenolics, vinylesters, polyester, polyurethane, thermoplastic resins (such as, nylon, polypropylene, and the like), and the like. In certain variations, the one or more resins may be intumescent based coated or laminated with expandable graphite so as to form one or more insulating char layers (not shown) on the composite material 350. The resin and/or insulating char layers may provide the molded battery cover (e.g., 100A, 100B) with some flame retardancy.

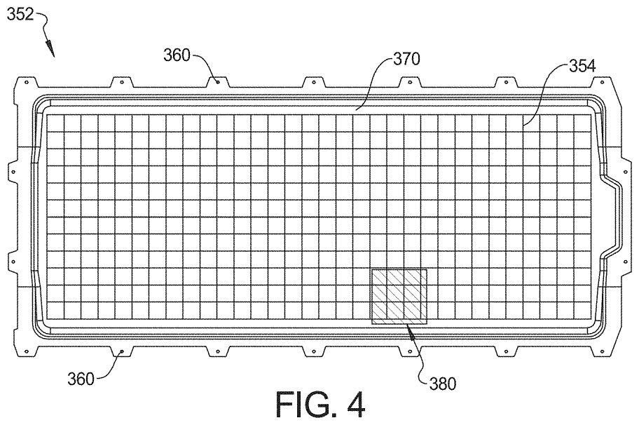

In further variations, the composite material 350 may include an integrated metallic mesh, which may provide additional crash resistant and helps electromagnetic capabilities. For example, FIG. 4 is top-down view of an example composite battery cover 352 having an integrated metallic mesh 354. Like composite battery covers 100A, 100B, the composite battery cover 352 illustrated in FIG. 4 includes a plurality of coupling members 360 for securing the composite battery cover 352 to an enclosure, such as an electric vehicle battery enclosure, and a main enclosing surface 370 that includes the one or more integral vent members 380. For example, as illustrated, the main enclosing surface 370 may include a single vent member 380. Each of the one or more integral vent members 380 may have an average diameter greater than or equal to about 25 mm to less than or equal to about 100 mm.

As illustrated, the metallic mesh 354 may be integrated into the composite material (like composite material 350) that defines the battery cover 352. In certain variations, the metallic mesh may be a wired mesh having a spacing (p) greater than or equal to about 2 inches to less than or equal to about 4 inches and a pore diameter (d) greater than or equal to about 0.2 mm to less than or equal to about 0.5 mm. In certain aspects, thick battery covers (e.g., 5.0 mm) may have larger diameters (e.g., 0.5 mm) and spacings (e.g., 4 inches). In other aspects, thin battery covers (e.g., 2.0 mm) may require smaller diameters (e.g., 0.2 mm) and spacings (e.g., 1 inch), so as to achieved the required strength so as to retain pieces of the battery cover in the event of a crash, such as side pole impact crashes.

With renewed reference to FIG. 3, in still further variations, a sealing material may be integrated with or coated on the composite sheet material 350. For example, a sealing material (such as, urethane, polyurethane, polychlorotrifluoroethylene, silicone, acrylate, synthetic rubber, nylon, and the like) may be separately introduced into a molding groove between the upper and lower dies 310, 320 prior to the placement of the composite sheet material 350. The sealing material may be combined with the composite sheet material 350 when the upper and lower dies 310, 320 are moved together and pressure applied. In this manner, the sealing material may be integrated with one or both sides of the composite sheet material 350. In other instances, the sealing material may be injected into the molding groove after the composite sheet material 350 has been placed between the upper and lower dies 310, 320, but prior to the upper and lower dies 310, 320 are moved together and pressure applied.

FIG. 5 is a top-down view of a composite battery cover 400 having one or more integral vent members 430. For example, like composite battery covers 100A, 100B, the composite battery cover 400 illustrated in FIG. 5 includes a plurality of coupling members 410 for securing the composite battery cover 400 to an enclosure, such as an electric vehicle battery enclosure, and a main enclosing surface 420 that includes the one or more integral vent members 430. For example, as illustrated, the main enclosing surface 420 may include a single vent member 430. Each of the one or more integral vent members 420 may have an average diameter greater than or equal to about 25 mm to less than or equal to about 100 mm.

The main enclosing surface 420 may include a composite material that comprises one or more resins including, for example, phenolic resins (such as, novolacs, resoles, and the like), thermoset epoxy, phenolics, vinylesters, polyester, polyurethane, thermoplastic resins (such as, nylon, polypropylene, and the like), and the like. In certain variations, the one or more resins may be intumescent based coated or laminated with expandable graphite so as to form one or more insulating char layers (not shown) on the main enclosing surface 420. The one or more integral vent members 430 may include polymeric materials, for example a polymeric composite having low yield and low melting temperatures (e.g., melting or softening temperature less than or equal to about 200° C.). For example, the one or more integral vent members 430 may include, for example, polypropylene, polyethylene, and the like. The one or more integral vent members 430 may be substantially pure polymeric domains. In this manner, the main enclosing surface 420 may define a first domain and the one or more integral vent members 430 may define one or more second domains. The one or more second domains are localized areas of weakness that will succumb to stress and fail so as to relieve or vent pressure prior to the first domain. For example, the one or more second domains may fail at a pressure greater than or equal to about 15 KPa

In various aspects, the present disclosure provides methods for preparing composite battery covers having one or more integral vents including one or more areas having variable thicknesses and/or fiber loadings and/or polymeric materials having low yield and low melting temperatures, such as illustrated in FIGS. 1A-1B and 5. In certain instances, compression molding processes may be used. In certain variations, the one or more integral vents (such as, vents 420 illustrated in FIG. 5) may be introduced prior to the molding process. In other variations, the one or more integral vents (such as, vents 420 illustrated in FIG. 5) may be introduced after the molding process.

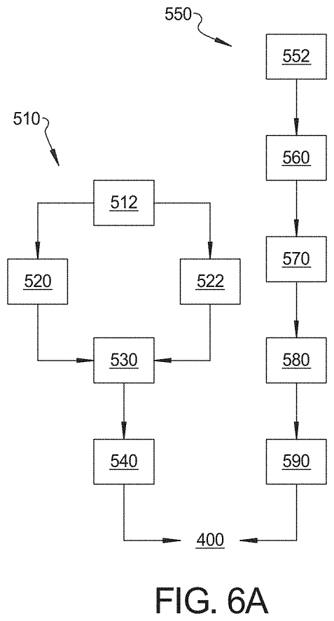

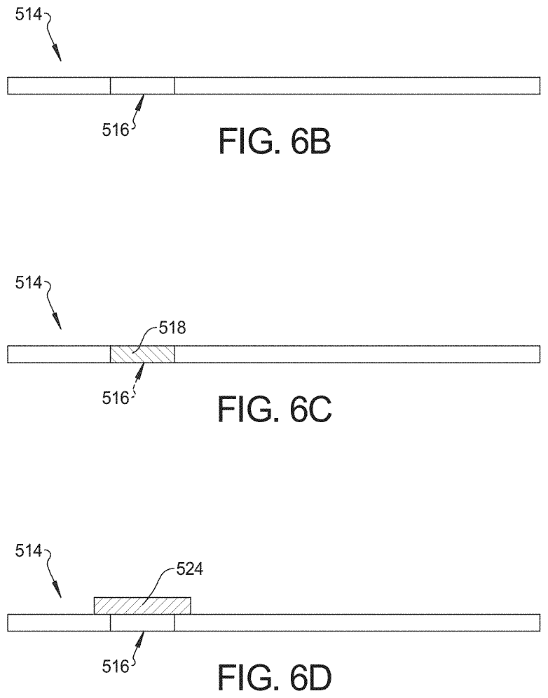

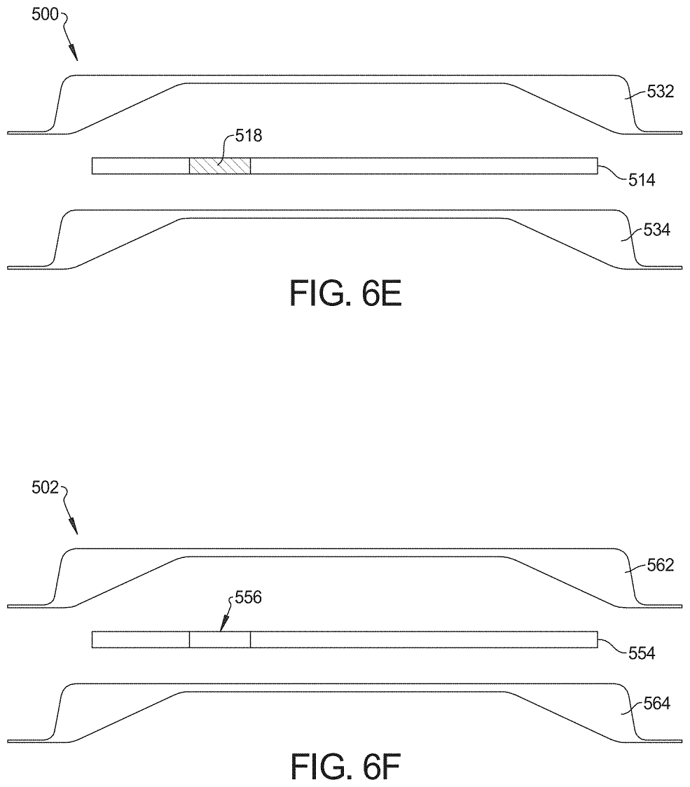

For example, as illustrated in FIG. 6A, in certain instances, a method 510 for preparing a composite battery cover 400 may include, for example, preparing 512 a composite sheet material 514. As illustrated in FIG. 6B, the composite sheet material 514 may include one or more openings or pores 516. Preparing 512 the composite sheet material 514 may include defining the one or more openings or pores 516. In certain instances, the one or more opening or pores 516 may be defined by trimming a preform composite sheet material. Each of the one or more openings or pores 516 may have an average diameter greater than or equal to about 25 mm to less than or equal to about 100 mm.

The method 510 includes filling or covering the one or more openings or pores 516. For example, the method 510 may include injecting 520 the polymeric materials 518 having low yield and low melting temperatures (e.g., neat resin) into each of the one or more openings or pores 516, such as illustrated in FIG. 6B. In other instances, as illustrated in FIG. 5A, the method 510 may instead include covering 522 each of the one or more openings or pores 516 with a patch 524 that comprises the polymeric materials having low yield and low melting temperatures (e.g., neat resin).

In each instances, the method 510 includes shaping 530 the composite sheet material 514 including the injected polymeric material 518 or the polymeric patch 524. The composite sheet material 514 may be shaped using a compression molding process. For example, as illustrated in FIG. 6E, the composite sheet material 514 may be disposed between upper and lower dies 532, 534 of a compression mold 500 having predetermined corresponding shapes. The upper and lower dies 532, 534 may be brought together and pressure and/or heat applied 530. Upon the application of pressure and/or heat the polymeric filler 518 may bond to the composite sheet material 514 and the polymeric patch 524 may melt and fill the opening 516 so that in each instance a continuous shape is formed. The polymeric filler 518 or the polymeric patch 524 define one or more vent members, like vent member 430 illustrated in FIG. 5. The method 510 further includes removing 540 the composite battery cover 400 from the compression mold.

In other instances, as illustrated in FIG. 6A, a method 550 for preparing a composite battery cover 400 may include, for example, preparing 552 a composite sheet material 554. Similar to composite sheet material 514 illustrated in FIG. 6B, the composite sheet material 554 may include one or more openings or pores 556 and preparing the composite sheet material 554 may include defining the one or more openings or pores. Each of the one or more openings or pores defined within the composite sheet material 554 may have an average diameter greater than or equal to about 10 mm to less than or equal to about 50 mm.

The method 550 includes shaping 560 the composite sheet material 554 including the one or more openings or pores 556. Similar to the composite sheet material 514 including the injected polymeric material 518 or the polymeric patch 524, the composite sheet material 554 including the one or more openings or pores 556 may be shaped using a compression molding process. For example, as illustrated in FIG. 6F, the composite sheet material 554 may be disposed between upper and lower dies 562, 564 of a compression mold 502 having predetermined corresponding shapes. The upper and lower dies 562, 564 may be brought together and pressure and/or heat applied 560. The method 550 further includes removing 570 the shaped composite sheet from the compression mold 500.

The shaped composite sheet has a general shape of a composite battery cover and includes one or more openings defined within a main surface of the shaped composite sheet. The method 520 further includes, after molding the composite sheet, inserting 580 a polymeric material 574 (for example, having a polygonal shape) within the openings 556. Heat and/or pressure are applied 590 so as to bond the polymeric material to the shaped composite sheet 572 and define a continuous battery cover having one or more vent members, like battery composite cover 400 including vent 430 as illustrated in FIG. 5. For example, the applied temperature may be greater than or equal to about 100° C. to less than or equal to about 150° C. The applied pressure may be greater than or equal to about 5 bars to less than or equal to about 10 bars.

In each instance, the composite battery covers having one or more integral vent members, such as composite battery covers like composite battery cover 100A illustrated in FIG. 1A, composite battery cover 100B illustrated in FIG. 1B, and/or composite battery cover 400 illustrated in FIG. 5, may further include one or more exhaust channels that are configured to direct exhaust release by the one or more integral vent members. For example, FIGS. 6A and 6B are top-down views of a similar composite battery covers 600A, 600B having one or more integral vent members 630A, 630B and one or more exhaust channels 640A, 640B.

In each instance, like composite battery cover 100A illustrated in FIG. 1A, composite battery cover 100B illustrated in FIG. 1B, and/or composite battery cover 400 illustrated in FIG. 5, the respective composite battery cover 600A, 600B includes a plurality of coupling members 610A, 600B for securing the composite battery cover 600A, 600B to an enclosure, such as an electric vehicle battery enclosure, and a main enclosing surface 620A, 620B that includes the one or more integral vent members 630A, 630B. For example, as illustrated, each main enclosing surface 620A, 620B may include four vent members 630A, 630B. The one or more integral vent members 630A, 630B may include embossments and/or depressions having variable thicknesses and/or fiber loadings and/or polymeric materials having low yield and low melting temperatures. The one or more exhaust channels 640A, 640B may form air flow channels in communication with at least one of the one or more integral vent members 630A, 630B for directional exhaust and venting.

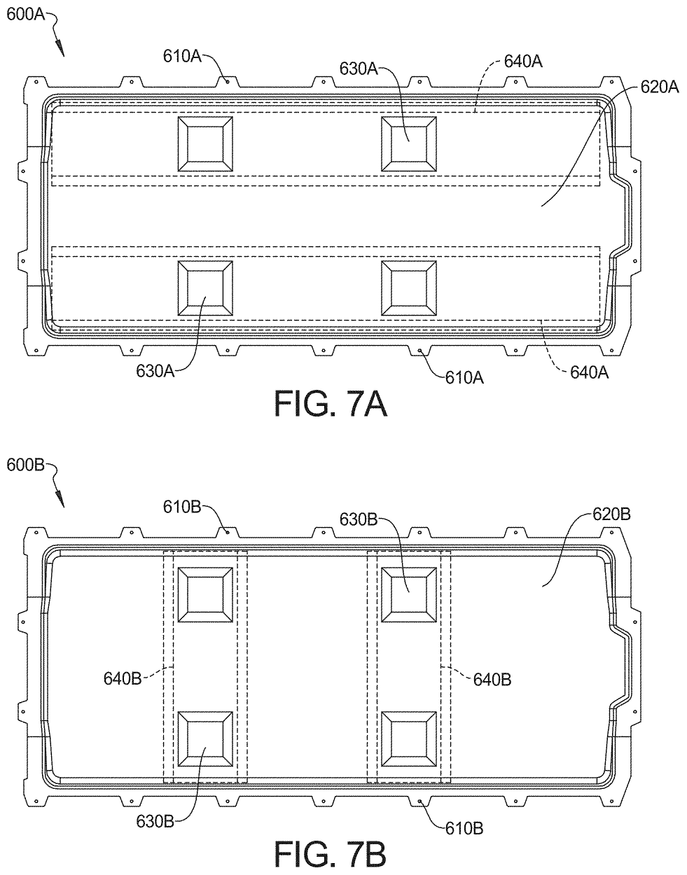

For example, as illustrated in FIG. 7A, the one or more exhaust channels 640A may be positioned along a longitudinal of the electric vehicle including the electric vehicle battery enclosure and composite battery cover 600A. A first exhaust channel of the one or more exhaust channels 640A may be in communication with first and second vent members of the one or more vent members 630A; and a second exhaust channel of the one or more exhaust channels 640A may be in communication with third and fourth vent members of the one or more vent members 630A.

As illustrated in FIG. 7B, the one or more exhaust channels 640B may be positioned along a cross-car direction of the electric vehicle including the electric vehicle battery enclosure and composite battery cover 600B. A first exhaust channel of the one or more exhaust channels 640B may be in communication with first and second vent members of the one or more vent members 630B; and a second exhaust channel of the one or more exhaust channels 640B may be in communication with third and fourth vent members of the one or more vent members 630B.

In each instances, the one or more exhaust channels 640A, 640B may include metallic, composite, or plastic materials. The one or more exhaust channels 640A, 640B may be bonded and/or welded onto a top surface of the respective battery cover 600A, 600B. The one or more exhaust channels 640A, 640B may each be in integration or in communication with one or more exhaust or vent channels that directs the air or exhaust out of the battery compartment, and ultimately, the electric vehicle.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A composite battery cover comprising:
a continuous sheet having a first stiffness; and
one or more vent members defined in the continuous sheet, wherein each of the one or more vent members comprises a first area having a second stiffness, wherein the second stiffness is different from the first stiffness.

2. The composite battery cover of claim 1, wherein the second stiffness is greater than or equal to about 5% to less than or equal to about 25% of the first stiffness.

3. The composite battery cover of claim 1, wherein the continuous sheet has a first average thickness and the first area has a second average thickness, wherein the first and second average thicknesses are different.

4. The composite battery cover of claim 1, wherein the continuous sheet has a first fiber loading and the first area has a second fiber loading, wherein the first and second fiber loadings are different.

5. The composite battery cover of claim 1, wherein the first area is a polymeric domain comprising a low-melting temperature polymer.

6. The composite battery cover of claim 1, wherein each of the one or more vent members further comprises:
a second area having a third stiffness, wherein the third stiffness is different from the first stiffness and the second stiffness.

7. The composite battery cover of claim 6, wherein the third stiffness is greater than or equal to about 75% to less than or equal to about 600% of the first stiffness.

8. The composite battery cover of claim 6, wherein the continuous sheet has a first average thickness, the first area has a second average thickness, and the second area has a third average thickness, wherein the first, second, and third average thicknesses are different.

9. The composite battery cover of claim 8, wherein the first average thickness is greater than or equal to about 2.0 mm to less than or equal to about 5.0 mm; the second average thickness is greater than or equal to about 0.2 mm to less than or equal to about 4.0 mm; and the third average thickness is greater than or equal to about 2.0 mm to less than or equal to about 6.0 mm.

10. The composite battery of claim 6, wherein the continuous sheet has a first fiber loading, the first area has a second fiber loading, and the second area has a third fiber loading, wherein the first, second, and third fiber loadings are different.

11. The composite battery of claim 10, wherein the first fiber loading is greater than or equal to about 30 vol. % to less than or equal to about 60 vol. %; the second fiber loading is greater than or equal to about 0 vol. % to less than or equal to about 60 vol. %; and the third fiber loading is greater than or equal to about 30 vol. % to less than or equal to about 60 vol. %.

12. The composite battery of claim 6, wherein the first area forms a substantially planar surface and the second area forms a bridge that extends between the substantially planar surface and a main surface of the continuous sheet.

13. The composite battery cover of claim 12, wherein the substantially planar surface defines a convex member having a maximum height greater than or equal to about 2 mm to less than or equal to about 10 mm.

14. The composite battery cover of claim 12, wherein the substantially planar surface defines a concave member having a maximum depth greater than or equal to about 2 mm to less than or equal to about 10 mm.

15. The composite battery cover of claim 13, further comprising:
one or more seal materials, wherein the one or more seal materials are integrated with the continuous sheet.

16. The composite battery cover of claim 1, further comprising:
an expandable graphite, wherein the expandable graphite is integrated with the continuous sheet.

17. The composite battery cover of claim 1, further comprising:
one or more exhaust channels configured to direct exhaust, wherein each exhaust channel is in communication with at least one of the one or more vent members.

18. A method for preparing a composite battery cover comprising a continuous sheet having one or more polymeric domains defined therein, the method comprising:
obtaining a composite sheet material having one or more openings, wherein the composite sheet material has a first fiber loading;
filling the one or more openings with a polymeric composite or covering the one or more opening with the polymeric composite so as to form a precursor sheet having one or more polymeric domains, wherein the polymeric composite has a second fiber loading and the first and second fiber loadings are different; and
applying heat and pressure to the precursor sheet so as to form the continuous sheet comprising the one or more polymeric domains.

19. The method of claim 18, further comprising:
shaping the composite sheet material having the one or more opening.

20. The method of claim 18, further comprising:
shaping the one or more continuous so as to form the composite battery cover.
